(19) United States
(12) Patent Application Publication
(10) Pub. No.: US 2023/0222648 A1
(43) Pub. Date: Jul. 13, 2023

(54) INFORMATION PROCESSING METHOD, INFORMATION PROCESSING SYSTEM, AND PROGRAM

(71) Applicant: LINKWIZ INCORPORATED, Hamamatsu (JP)

(72) Inventors: Go FUKINO, Hamamatsu (JP); Takumi KURITA, Hamamatsu (JP); Akihide KATO, Hamamatsu (JP)

(21) Appl. No.: 17/996,309

(22) PCT Filed: Mar. 16, 2021
(86) PCT No.: PCT/JP2021/010528

§ 371 Date: Oct. 14, 2022

(30) Foreign Application Priority Data
Apr. 17, 2020 (JP) 2020-074029

(51) Int. Cl. G06T 7/00; G06T 1/00

(52) U.S. Cl. CPC G06T 7/001; G06T 1/0014; G06T 2207/30164

(57) ABSTRACT

The present disclosure provides an information processing method for performing the following steps, and the resulting information includes captured image data including at least the robot arm every predetermined period: a step of causing a captured image data acquisition unit to acquire captured image data of an imaging target at least including a robot arm and a control object; a step of causing a control unit to change a state of the control object every predetermined period based on user setting; an image comparison step of causing an image comparison unit to compare the captured image data with reference image data; and a step of causing a result information acquisition unit to detect a predetermined state change based on a result of the comparison in the image comparison step, acquire result information regarding a work of the robot arm, and store the result information in a result information storage unit.

### TECHNICAL FIELD

The present invention relates to an information processing method, an information processing system, and a program.

### BACKGROUND ART

In the related art, industrial products have been produced in a production line including a work robot (See, for example, Patent Literature 1).

### CITATION LIST

### Patent Literature

Patent Literature 1: JP 2017-109289 A

### SUMMARY

### Technical Problem

In such a production line, it is necessary to further improve the productivity of the work robot, but construction of a data acquisition system for obtaining accurate productivity has not been sufficient.

Furthermore, various events may occur around the production line, a system for checking the event occurrence status at least afterward is required, and it is desirable to construct the system at low cost in the viewpoint of management.

The present invention has been made in view of such a background, and an object of the present invention is to provide a technique for particularly improving productivity of a work robot by using an image acquired by an imaging apparatus, and a technique for enabling checking of a predetermined event occurrence status at least afterward. Furthermore, an object of the present invention is to provide a technique for checking a work status related to a person who works particularly in a production line or the like and improving work efficiency.

### Solution to Problem

According to a main aspect of the present invention for solving the above-described problem, there is provided an information processing method including: a step of causing a captured image data acquisition unit to acquire captured image data of an imaging target at least including a robot arm and a control object; a step of causing a control unit to change a state of the control object every predetermined period based on user setting; an image comparison step of causing an image comparison unit to compare the captured image data with reference image data; and a step of causing a result information acquisition unit to detect a predetermined state change based on a result of the comparison in the image comparison step, acquire result information regarding a work of the robot arm, and store the result information in a result information storage unit, in which the result information includes captured image data including at least the robot arm every predetermined period.

Other problems disclosed in the present application and methods for solving the problems will be clarified by the embodiments and drawings of the invention.

### Advantageous Effects of Invention

According to the present invention, there is provided a technique for particularly improving productivity of a work robot by using an image acquired by an imaging apparatus, and a technique for enabling checking of a predetermined event occurrence status at least afterward. Furthermore, there can be provided a technique for checking a work status related to a person who works particularly in a production line or the like and improving work efficiency.

### BRIEF DESCRIPTION OF DRAWINGS

FIG. 1 is a diagram illustrating an overall configuration example of an information processing system 100 of the present embodiment.

FIG. 2 is a diagram illustrating a hardware configuration example of a terminal 1 according to the present embodiment.

FIG. 3 is a diagram illustrating a functional configuration example of a terminal 1 according to the present embodiment.

FIG. 4 is a diagram illustrating a display example of a terminal 1 according to the present embodiment.

FIG. 5 is a diagram illustrating a display example of a terminal 1 according to the present embodiment.

FIG. 6 is a diagram illustrating a display example of a terminal 1 according to the present embodiment.

FIG. 7 is a diagram illustrating a display example of a terminal 1 according to the present embodiment.

FIG. 8 is a diagram illustrating a display example of a terminal 1 according to the present embodiment.

FIG. 9 is a diagram illustrating a display example of a terminal 1 according to the present embodiment.

FIG. 10 is a diagram illustrating an example of a flowchart of an information processing method according to the present embodiment.

FIG. 11 is a diagram illustrating an example of a flowchart of an application operation method according to the present embodiment.

### DESCRIPTION OF EMBODIMENTS

The contents of the embodiments of the present invention will be listed and described. The present invention has, for example, the following configuration.

### Item 1

An information processing method including:

a step of causing a captured image data acquisition unit to acquire captured image data of an imaging target at least including a robot arm and a control object;

a step of causing a control unit to change a state of the control object every predetermined period based on user setting;

an image comparison step of causing an image comparison unit to compare the captured image data with reference image data; and

a step of causing a result information acquisition unit to detect a predetermined state change based on a result of the comparison in the image comparison step, acquire result information regarding a work of the robot arm, and store the result information in a result information storage unit,

in which the result information includes captured image data including at least the robot arm every predetermined period.

### Item 2

The information processing method according to item 1,

in which the result information is information regarding whether or not the robot arm holds a workpiece.

### Item 3

The information processing method according to item 1 or 2,

in which an imaging apparatus for acquiring the captured image data is a Web camera.

### Item 4

An information processing system including:

a captured image data acquisition unit configured to acquire captured image data of an imaging target at least including a robot arm and a control object;

a control unit configured to change a state of the control object every predetermined period based on user setting;

an image comparison unit configured to compare the captured image data with reference image data; and

a result information acquisition unit configured to detect a predetermined state change based on a result of the comparison in the image comparison unit, acquire result information regarding a work of the robot arm, and store the result information in a result information storage unit,

in which the result information includes captured image data including at least the robot arm every predetermined period.

### Item 5

A program for causing a computer to execute an information processing method, the program causing the computer to, as the information processing method, execute:

a step of causing a captured image data acquisition unit to acquire captured image data of an imaging target at least including a robot arm and a control object;

a step of causing a control unit to change a state of the control object every predetermined period based on user setting;

an image comparison step of causing an image comparison unit to compare the captured image data with reference image data; and

a step of causing a result information acquisition unit to detect a predetermined state change based on a result of the comparison in the image comparison step, acquire result information regarding a work of the robot arm, and store the result information in a result information storage unit,

in which the result information includes captured image data including at least the robot arm every predetermined period.

### Details of Embodiments

A specific example of an information processing system 100 according to an embodiment of the present invention will be described below with reference to the drawings. Note that the present invention is not limited to these examples, but is indicated by the claims, and is intended to include all modifications within the meaning and scope equivalent to the claims. In the following description, in the accompanying drawings, the same or similar elements are denoted by the same or similar reference numerals and names, and the overlapping description of the same or similar elements may be omitted in the description of each embodiment. Furthermore, the features described in each embodiment are also applicable to other embodiments as long as the features do not contradict each other.

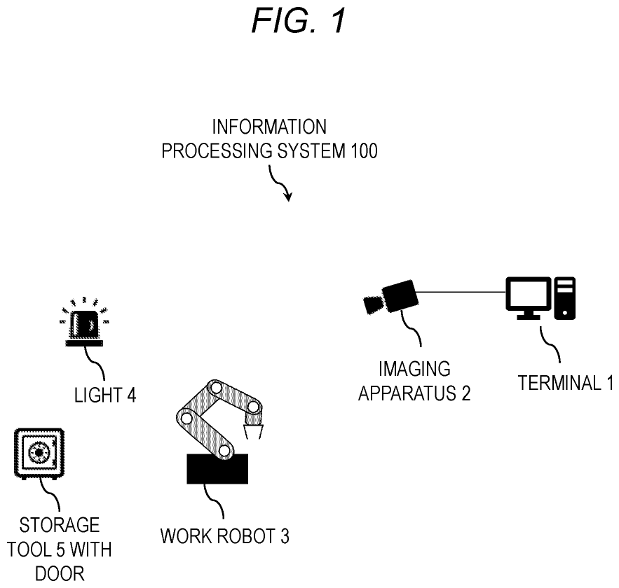

FIG. 1 is a diagram illustrating an example of the information processing system 100 of the present embodiment. As illustrated in FIG. 1, the information processing system 100 according to the present embodiment includes a terminal 1 and an imaging apparatus 2. The terminal 1 and the imaging apparatus 2 are connected so as to be capable of communicating with each other in a wired or wireless manner. The imaging apparatus 2 images an imaging target (for example, a work robot 3 such as a robot arm, a light 4, a storage tool 5 with a door, and the like), and transmits a captured image (a still image or a moving image) of the imaging target to the terminal 1. Note that FIG. 1 is merely an example and is not limited to the illustrated configuration.

### Terminal 1

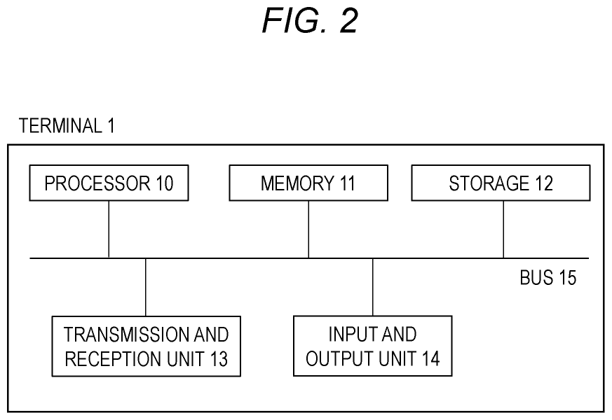

FIG. 2 is a diagram illustrating a hardware configuration of the terminal 1. The terminal 1 may be, for example, a general-purpose computer such as a personal computer, or may be logically implemented by cloud computing. Note that the illustrated configuration is an example, and other configurations may be included.

The terminal 1 includes at least a processor 10, a memory 11, a storage 12, a transmission and reception unit 13, an input and output unit 14, which are electrically connected to each other through a bus 15.

The processor 10 is an arithmetic device that controls the entire operation of the terminal 1 and performs at least control of transmission and reception of data and the like with the imaging apparatus 2, information processing necessary for execution of an application, authentication processing, and the like. For example, the processor 10 is a central processing unit (CPU) and/or a graphics processing unit (GPU), and executes a program or the like for the present system stored in the storage 12 and expanded in the memory 11 to perform each information processing.

The memory 11 includes a main storage including a volatile storage device such as a dynamic random access memory (DRAM) and an auxiliary storage including a nonvolatile storage device such as a flash memory or a hard disc drive (HDD). The memory 11 is used as a work area or the like of the processor 10, and stores a basic input and output system (BIOS) executed when the terminal 1 is started, various setting information, and the like.

The storage 12 stores various programs such as an application program. A database storing data used for each processing may be constructed in the storage 12.

The transmission and reception unit 13 connects the terminal 1 to at least the imaging apparatus 2, and transmits and receives data or the like according to an instruction of the processor. Note that the transmission and reception unit 13 is configured in a wired or wireless manner, and in a case where the transmission and reception unit 13 is configured in the wireless manner, the transmission and reception unit 13 may be configured by, for example, a short-range communication interface such as WiFi, Bluetooth (registered trademark), or Bluetooth Low Energy (BLE).

The input and output unit 14 is an information input device such as a keyboard or a mouse, and an output device such as a display.

The bus 15 is commonly connected to the above-described elements, and transmits, for example, an address signal, a data signal, and various control signals.

### Function of Terminal 1

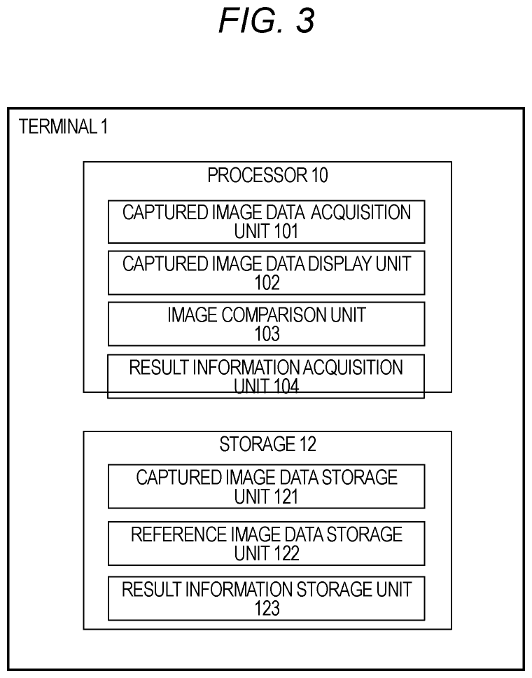

FIG. 3 is a block diagram illustrating functions implemented in the terminal 1. In the present embodiment, the processor 10 of the terminal 1 includes a captured image data acquisition unit 101, a captured image data display unit 102, an image comparison unit 103, and a result information acquisition unit 104. Furthermore, the storage 12 of the terminal 1 includes a captured image data storage unit 121, a reference image data storage unit 122, and a result information storage unit 123.

The captured image data acquisition unit 101 controls the imaging apparatus 2 according to an instruction from the processor 10 of the terminal 1, and acquires a captured image of an imaging target (for example, the work robot 3, the light 4, the storage tool 5 with a door, and the like). The acquired captured image data is, for example, still image data or moving image data, and is stored in the captured image data storage unit 121. Note that the captured image data storage unit 121 may store the captured image data at all times, or may store the captured image data thinned out at predetermined time intervals. For example, in a case where a predetermined operation condition such as one cycle of the work robot 3 (a serial operation cycle in which the work robot 3 moves from an initial position and returns to the initial position again) is satisfied, the captured image data storage unit 121 may deletes the oldest captured image data and store the captured image data which satisfies the predetermined operation condition by a predetermined number of times set by the user. Furthermore, as will be described later, a predetermined event set by the user may be detected, and only the captured image data obtained when at least the event occurs (for example, at least captured image data obtained during a predetermined time before or after occurrence of the event is included) may be stored.

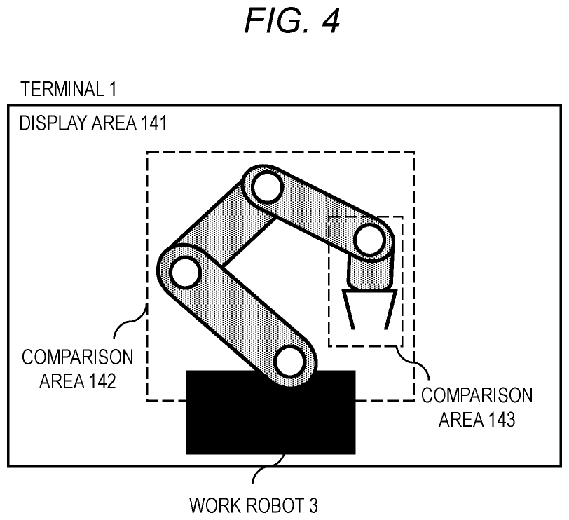

The captured image data display unit 102 displays the captured image data acquired by the captured image data acquisition unit 101 in a display area 141 of the input and output unit 14 of the terminal 1, for example, as illustrated in FIG. 4.

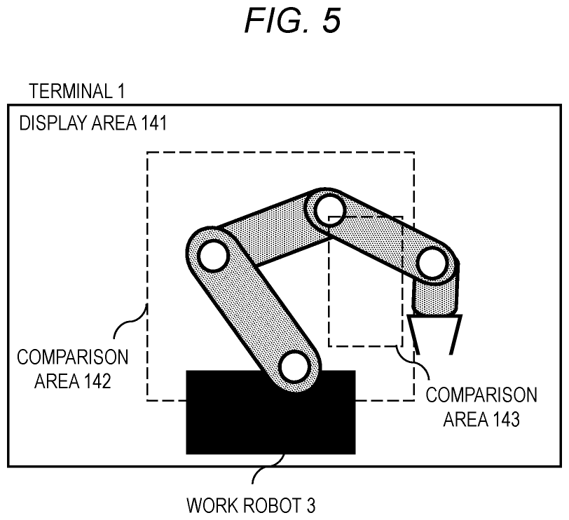

As illustrated in FIG. 4, the image comparison unit 103 performs processing of comparing captured image data of a comparison area 142 including the entire imaging target or captured image data of a comparison area 143 including only a part of the imaging target with a reference image data (for example, captured image data in which the imaging target is in a predetermined state, such as the captured image data obtained by imaging the state of the initial position in the example of the work robot 3 described above or the captured image data in a case where the imaging target is in a normal state in the example of the event described above) stored in the reference image data storage unit 122. The method of comparison between both two pieces of the captured image data is, for example, a method of detecting a matching rate between both two pieces of the captured image data. In a case where the matching rate is a predetermined value or more, it may be determined as “matched”, and in other cases (for example, the state of FIG. 5 and the like), it may be determined as “unmatched”. Note that the above-described comparison area 142 or comparison area 143 may be an area invisible to the user, but may be an area visible to the user as, for example, a frame line in the display area 141.

The result information acquisition unit 104 acquires the result information (including comparison result information such as the above-described matching rate and calculation result information calculated based on the comparison result information) according to the result of the comparison processing in the image comparison unit 103. The result information is stored in the result information storage unit 123. For example, the productivity of the work robot 3 or the like can be confirmed by counting the number of times of “matched” described above. That is, as described above, for example, in the work robot 3, one cycle of returning to the initial position (“matched” state) in FIG. 4 after the movement as illustrated in FIG. 5 (“unmatched” state) from the initial position (“matched” state) in FIG. 4 can be determined by counting the number of times of “matched”. According to this, it is possible to acquire calculation result information such as a time required for one cycle and the number of cycles within a predetermined time. Therefore, the present system can confirm the productivity in this manner.

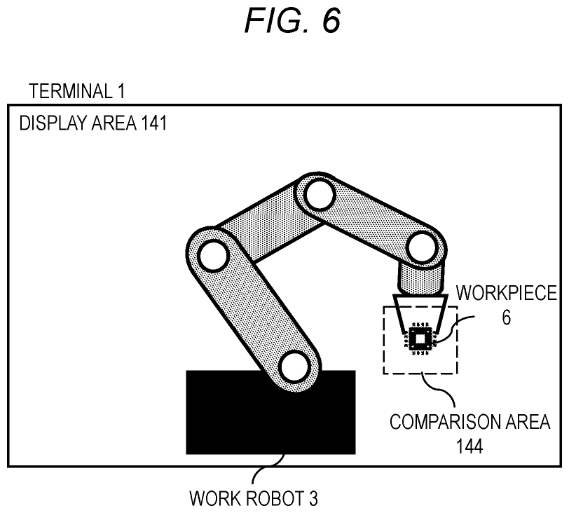

Furthermore, for example, in the example of the event described above, the result information acquisition unit 104 can acquire information regarding whether an event occurs and the captured image data obtained by capturing the event occurrence as the result information, and the like based on the image comparison result described above. That is, as illustrated in FIG. 6, for example, an abnormal state such as whether or not the work robot 3 holds a workpiece 6 (for example, holding by a grip, suction, or the like) may be determined as the abnormal state by using, for example, a comparison area 144 including the workpiece 6 based on the result information of “matched” (state of holding the workpiece 6) or “unmatched” (state of not holding the workpiece 6) in the area.

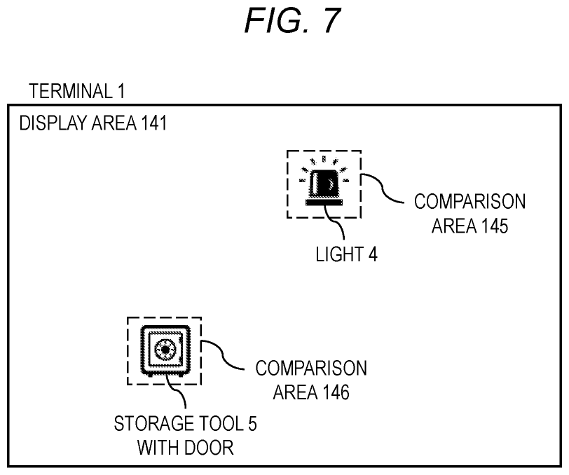

Furthermore, for example, as an example of the event described above, as illustrated in FIG. 7, the result information acquisition unit 104 can acquire, as result information, a result of determining an imaging target that cooperates with another system or another device, such as whether or not the light 4 is turned on (for example, in a case where the light 4 is turned on, a failure occurring in the cooperating device, in particular, the result obtained when the type or degree of the failure can be determined depending on a color and lighting place, or the like), or an imaging target that is normal in a predetermined state, such as whether the storage tool 5 with a door is opened or closed. According to this, for example, it is possible to confirm, as the result information, the operation rate (rate of operation without failure) of the device with which the light 4 cooperates, or it is possible to confirm, as the result information, occurrence of an event in an abnormal state such as a failure state of the device or a state in which the door of the storage tool 5 with a door is not closed, and in particular, it is possible for the user to confirm a status at the time of occurrence of the event by also acquiring captured image data at the time of occurrence of the event.

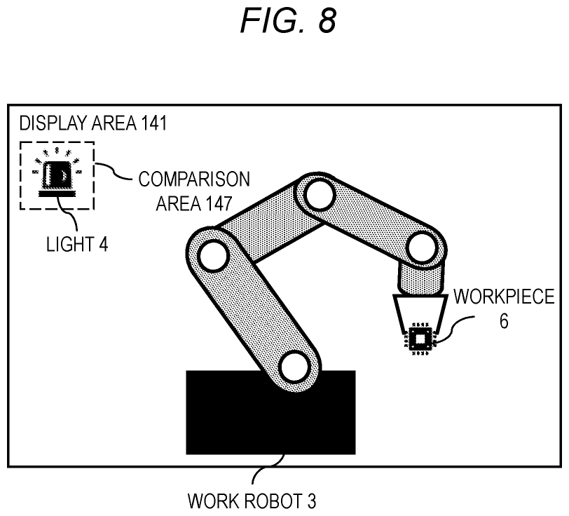

Moreover, captured image data can be acquired at any timing by using this. That is, as illustrated in FIG. 8, for example, when it is determined, in a comparison area 147, whether or not a device such as the light 4 of which the state change can be controlled at a predetermined timing set by the user with the terminal 1 or another system is operated, captured image data can be acquired at the timing, for example, a status at a timing when an abnormal state is likely to occur in the imaging target can be confirmed by the user. In particular, by using such a method, it is possible to acquire the captured image data and confirm a status at a predetermined timing only by adding the present system to the existing system.

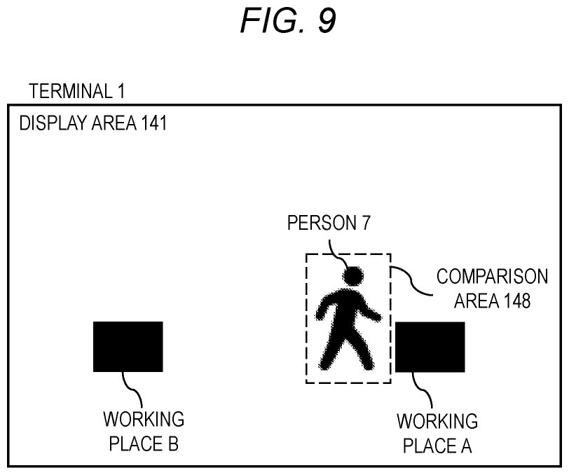

Furthermore, the imaging target is not limited to the device, and for example, as illustrated in FIG. 9, by comparing operation of performing a predetermined work (for example, operation of extending a hand to a predetermined position, operation of using a predetermined tool, and the like) and an image of a person who works in a predetermined place (for example, working places A and B) together with a person 7 working in the production line by the image comparison unit 103, similarly to the above description, result information regarding whether normal operation is performed and result information regarding a working cycle with a series of processes (for example, the working place A is an initial position, another work is performed after movement to the working place B, and then returning to the working place A is performed again) may be acquired by the result information acquisition unit 104. According to this, it is possible to confirm the productivity of the worker and confirm a status regarding an artificial event (for example, a procedure error, a work operation error, or the like), and it is possible to acquire an evaluation index (for example, an error rate, work efficiency, and the like) for the person 7 or educational materials. Furthermore, the configuration illustrated in FIG. 8 may also be adopted for the person 7.

### Imaging Apparatus 2

The imaging apparatus 2 may use any resolving power, resolution, an imaging angle of view, an imaging distance, or the like as long as the imaging apparatus 2 has a performance that enables necessary image comparison. However, in particular, an inexpensive camera such as a web camera is more preferable for constructing a system at low cost. Furthermore, instead of one imaging apparatus 2 as illustrated in FIG. 1, a plurality of the imaging apparatuses 2 may be installed according to a positional relationship of imaging targets or the like. Moreover, a plurality of the imaging apparatuses 2 may have similar settings or may have different settings. For example, an imaging apparatus for cycle confirmation and an imaging apparatus for event occurrence confirmation may be installed. At this time, the imaging targets may be different from each other or the same as each other, but in order to construct a system at low cost, it is preferable that the number of imaging targets is the minimum required.

### Flowchart of Information Processing Method

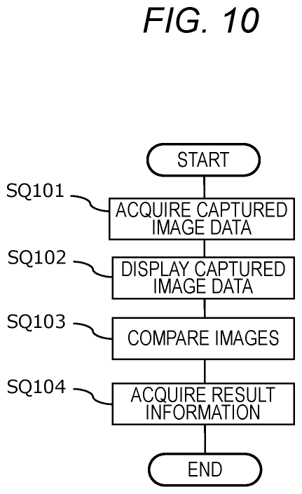

FIG. 10 is an example of a flowchart of the information processing method in the information processing system 100 of the present embodiment.

First, the user acquires captured image data of an imaging target such as the work robot 3 by using the imaging apparatus 2 under control of the terminal 1 (SQ

Next, the captured image data acquired in SQ 101 is displayed on the terminal 1 by using the captured image data display unit 102 (SQ 102). However, when the image comparison in SQ 103, which is the next step, is possible, the display of the captured image data in SQ 102 may not be executed.

Next, the captured image data acquired in SQ 101 and reference image data are compared by the image comparison unit 103 (SQ 103).

Next, the result information acquisition unit 104 acquires result information based on the comparison result in SQ 103 (SQ 104).

Therefore, the information processing system 100 of the present embodiment can provide a technique for particularly improving productivity of a work robot by using an image acquired by an imaging apparatus, and a technique for enabling checking of a predetermined event occurrence status at least afterward.

### Flowchart of Application Operation

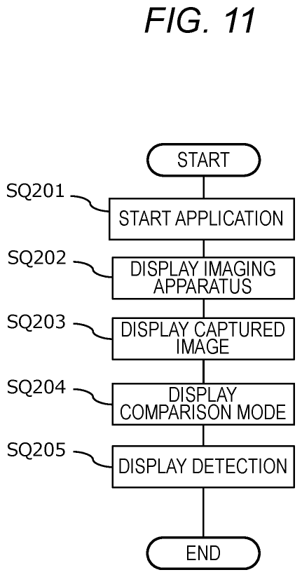

FIG. 11 is an example of a flowchart of the application operation in the information processing system 100 of the present embodiment.

First, the user starts an application for operating the information processing system 100 (SQ 201).

Next, the terminal 1 displays the imaging apparatus 2 connected to the terminal 1 in a wireless or wired manner, and enables selection of the imaging apparatus 2 of which setting is to be edited (SQ 202).

Next, the terminal 1 displays the captured image of the selected imaging apparatus 2 in the display area of the input and output unit (SQ 203).

Next, the terminal 1 displays a comparison mode of the selected imaging apparatus 2 and enables selection (SQ 204). The comparison mode includes, for example, as described above, at least one of a comparison mode in which comparison for confirming a cycle is performed, a comparison mode in which comparison for determining whether or not a state is a normal state is performed, or a comparison mode in which comparison for determining whether or not it is a predetermined timing set by the user is performed. Furthermore, at the time of occurrence of the event, it may be possible to set in which period the captured image data is stored before and after the event occurrence timing.

Next, in a case where the terminal 1 is detected as an object in the above-described comparison mode, the terminal 1 displays the object in the display area of the input and output unit such that the detection can be confirmed (SQ 205). For example, a predetermined mark may be displayed in the display area, or the frame of the captured image may be emphasized by a color. Furthermore, when the user selects the predetermined mark or the captured image, the stored captured image data may be displayed in a confirmable manner.

Although the present embodiment has been described above, the above-described embodiment is for facilitating understanding of the present invention, and is not intended to limit and interpret the present invention. The present invention can be modified and improved without departing from the gist thereof, and the present invention includes equivalents thereof.

### REFERENCE SIGNS LIST

1 Terminal
2 Imaging apparatus
3 Work robot
4 Light
5 Storage tool with door

1. An information processing method comprising:
causing a captured image data acquisition unit to acquire captured image data of an imaging target at least including a robot arm and a control object;
causing a control unit to change a state of the control object every predetermined period based on user setting;
causing an image comparison unit to compare the captured image data with reference image data; and
causing a result information acquisition unit to detect a predetermined state change based on a result of the comparison, acquire result information regarding a work of the robot arm, and store the result information in a result information storage unit,
wherein the result information includes captured image data including at least the robot arm every predetermined period.

2. The information processing method according to claim 1,
wherein the result information is information regarding whether or not the robot arm holds a workpiece.

3. The information processing method according to claim 1,
wherein an imaging apparatus for acquiring the captured image data is a Web camera.

4. An information processing system comprising:
a captured image data acquisition unit configured to acquire captured image data of an imaging target at least including a robot arm and a control object;
a control unit configured to change a state of the control object every predetermined period based on user setting;
an image comparison unit configured to compare the captured image data with reference image data; and
a result information acquisition unit configured to detect a predetermined state change based on a result of the comparison in the image comparison unit, acquire result information regarding a work of the robot arm, and store the result information in a result information storage unit,
wherein the result information includes captured image data including at least the robot arm every predetermined period.

5. A program for causing a computer to execute an information processing method, the program causing the computer to, as the information processing method, execute the steps of:
causing a captured image data acquisition unit to acquire captured image data of an imaging target at least including a robot arm and a control object;
causing a control unit to change a state of the control object every predetermined period based on user setting;
causing an image comparison unit to compare the captured image data with reference image data; and
causing a result information acquisition unit to detect a predetermined state change based on a result of the comparison, acquire result information regarding a work of the robot arm, and store the result information in a result information storage unit,
wherein the result information includes captured image data including at least the robot arm every predetermined period.

6. The information processing method according to claim 2,
wherein an imaging apparatus for acquiring the captured image data is a Web camera.
